(19) United States
(12) Patent Application Publication
(10) Pub. No.: US 2013/0086999 A1
(43) Pub. Date: Apr. 11, 2013

(54) APPARATUS AND METHOD FOR TESTING USABILITY

(71) Applicants: Janne Pitkanen, Helsinki (FI); Matti Pitkaranta, Hyvinkaa (FI)

(72) Inventors: Janne Pitkanen, Helsinki (FI); Matti Pitkaranta, Hyvinkaa (FI)

(21) Appl. No.: 13/703,124

(22) PCT Filed: Jun. 21, 2011
(86) PCT No.: PCT/FI2011/050593

§ 371 Date: Dec. 10, 2012

(30) Foreign Application Priority Data
Jun. 22, 2010 (FI) 20105723

(51) Int. Cl. G01D 15/00

(52) U.S. Cl. CPC G01D 15/00
USPC 73/865.8

(57) ABSTRACT

An apparatus and method for testing usability. The apparatus for usability testing has an output capture module for capturing at least one type of output, an input capture module for capturing at least one type of input, a user trigger capture module for capturing at least one type of test user trigger, and at least one storage module for saving at least some of the captured events. The user trigger capture module and the storage module are connected to an object to be tested independently thereof.

### BACKGROUND OF THE INVENTION

The invention relates to an apparatus for usability testing, the apparatus comprising an output capture module for capturing at least one type of output, an input capture module for capturing at least one type of input, a user trigger capture module for capturing at least one type of test user trigger, and at least one storage module for saving at least some of the captured events.

The invention further relates to a method for usability testing, the method comprising capturing at least one type of output associated with an object to be tested, capturing at least one type of input associated with the object to be tested, capturing at least one type of user trigger of a critical event and storing at least part of the outputs and inputs associated with the critical event.

Usability design and testing receives increasing attention in the development of products and services. However, in many cases existing methods of usability testing are problematic and therefore comprehensive usability assurance is extremely expensive and time-consuming. For example, analysis of usage situations in controlled tests carried out in usability laboratories are laborious and the number of users tested remains small, not to mention the fact that the test situation does not even correspond to a real environment of use. Usability testing based on questionnaires, in turn, allows a large sample to be taken, but requires the test users to analyse their own sentiments and produces to a large extent answers to questions that are trivial to the user or too superficial. Technical solutions applied to usability testing are mostly whipped up by each company for their own use and a specific purpose. They mostly consist of conventional data recording and processing devices, such as video cameras shooting a user testing a PC application and separate computers for making analyses. The analysis of the situations of use is difficult, because usually they have to be dealt with one by one, and the user reactions must be evaluated separately for each situation. A problem with observations made without any tools is that the observation situations are artificial and it takes a trained staff and a lot of time to prepare, carry out and analyse the situations.

Prior art also knows apparatuses for testing usability during the execution of a computer program, for example, by capturing outputs and inputs at critical moments with different tools. Examples of prior art solutions have been disclosed e.g. in publications U.S. Pat. No. 5,793,948, U.S. Pat. No. 6,237.138, U.S. Pat. No. 7,184,918 and EP 1914634. In U.S. Pat. No. 5,793,948 events to be captured and analysed are identified on the basis of predetermined reference events. In U.S. Pat. No. 6,237.138 an operation controller attached to a computer on which an application to be tested is running is used to detect a critical usage event. In U.S. Pat. No. 7,184,918 a computer for capturing computer operations and storing a plural number of input flows is provided with a display for showing the captured events. The input flows must be available in the recording computer at the moment of capture, and the same computer is used for analysing the captured events. EP1914634 discloses the capture of a mobile device display and user inputs, and the transmission of these by a mobile device and a communication device for visualisation on a computer.

### BRIEF DESCRIPTION OF THE INVENTION

It is an object of the present invention to provide a new type of apparatus and method for testing usability.

The apparatus of the invention is characterized in that the user trigger capture module and the storage module are connected to an object to be tested independently thereof.

The method of the invention is characterized in that the outputs, inputs and critical events are captured and stored independently of the object to be tested.

The disclosed solution has an output capture module for capturing at least one type of output, an input capture module for capturing at least one type of input, a user trigger capture module for capturing at least one type of test user trigger, and at least one storage module for saving at least some of the captured events. The user trigger capture module and the storage module are connected to an object to be tested independently thereof. The apparatus is therefore provided with an arrangement for safeguarding a time-link storage capability without affecting the amount of resources available to the object to be tested. If the object to be tested is a computer program, for example, capturing is not discontinued due to tilting of the computer and/or its restart. Moreover, time remains in synchronism with real time in relation to the start time moment of the storage. Further still, the object to be tested is not affected in any way, i.e. its operation does not slow down nor does its stability suffer or the progress of its performance change in any way due to the test arrangement. The disclosed solutions allows to avoid for example a computer program integrated to the object under study or a background process for storing and sending log data. The disclosed solution makes it possible to obtain information of situations of use that would otherwise not have been possible to define or the examination of which would be too laborious. The solution also interferes with use extremely little, if at all. All in all, the storage apparatus as such does not disturb the situation of use. In the disclosed solution, the identification of critical events is not restricted to predetermined reference events. The method of expression of a critical event does not depend on the operation of the operation control devices of the object to be tested. Capturing does not need to take place in a centralized manner during testing, nor does the machine producing stored events need a display because the captured events may be stored to an externally readable or transferrable memory. Moreover, the transfer for inspection of the capturing information flow and the event to be stored is not dependent on the communications devices of the object to be tested.

According to an embodiment, the user trigger capture module and the storage module are connected between the object to be tested and a user in a physical manner separated of the object to be tested. This allows to ensure that the testing arrangement does not affect the object to be tested. Further, the testing arrangement is easy and simple adjust to an existing object without knowledge of the internal operation of the object to be tested.

In this specification the term ‘user trigger’ refers to a conscious action by a user. Hence the user trigger may be press of a button, for example, by which the user expresses his/her opinion of an event of use. On the other hand, the user trigger may also be some other predetermined and arranged measure consciously taken by the user to provide feedback on a situation of use. Examples of such measures include movement, such as a hand wave or a specific sound or some other predetermined and agreed action that is recordable. In that case the user trigger may be captured by means of a voice or motion detection device or method known per se.

### BRIEF DESCRIPTION OF THE FIGURES

Some embodiments of the invention will be explained in greater detail in the attached drawings, in which

FIG. 1 is a schematic view of a usability test apparatus;

FIG. 2 is a schematic view of a second usability test apparatus,

FIG. 3 is a schematic side view of the apparatus of FIG. 2,

FIG. 4 is a schematic view of a third usability test apparatus, and

FIG. 5 is a schematic block diagram of the capturing of critical events.

For the sake of clarity, some embodiments of the invention are simplified in the figures. Similar parts are denoted with the same reference numerals in the figures.

### DETAILED DESCRIPTION OF THE INVENTION

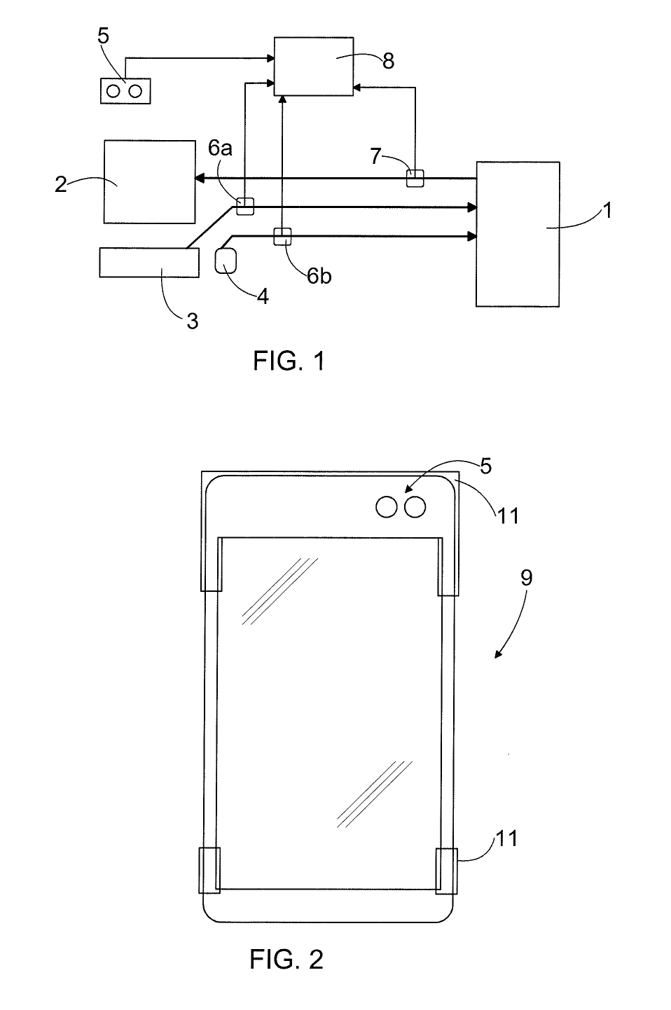

FIG. 1 shows an apparatus for testing usability. The apparatus in question is suitable for testing the usability of a computer software, for example. A computer program is executed in a computer 1 that has a display 2, a keyboard 3 and a mouse 4 connected thereto. The computer 1 comprises a memory, processor, display driver, etc. in manner known per se.

For the usability testing, the arrangement has an apparatus connected thereto, the apparatus being provided with a user trigger capture module 5, input capture modules 6a and 6b, output capture module 7 and storage module 8.

The user trigger capture module 5 may comprise for example two push buttons, one of which the user presses when a functionality of an object to be tested, such as a computer program, pleases the user, whereas the other one s/he pushes in a reverse case. This indicates thus the moment when a critical event of use has taken place.

The input capture modules 6a and 6b may be connected to a line or wire, for example, which in turn may connect the keyboard 3 and the mouse 4, respectively, to the computer 1.

The output capture module 7 may be similarly connected to a lead between the computer 1 and the display 2. A video signal divider, for example, may be used for this purpose. A video signal may be captured using an external screen capturer, for example. The operation of an external screen capturer is based on a VGA or DVI video signal connected to one end thereof, while the other end is connected to a USB port of the capturing computer. In other words, the capturer transforms the signal to a digital flow passing through the USB port. An advantage of the external screen capturer is that it is easy to use on a number of different machines because it does not need to be installed inside the machine. The storage module 8 may be for example a small computer and the capture modules 5, 6a, 6b and 7 may be connected thereto.

In other words, the usability testing apparatus is connected without having to make any changes to the object to be examined, which in the case of FIG. 1 is a computer software assembly. Again, all the necessary information is collected from between the object to be examined and the user, without acting on the object to be examined.

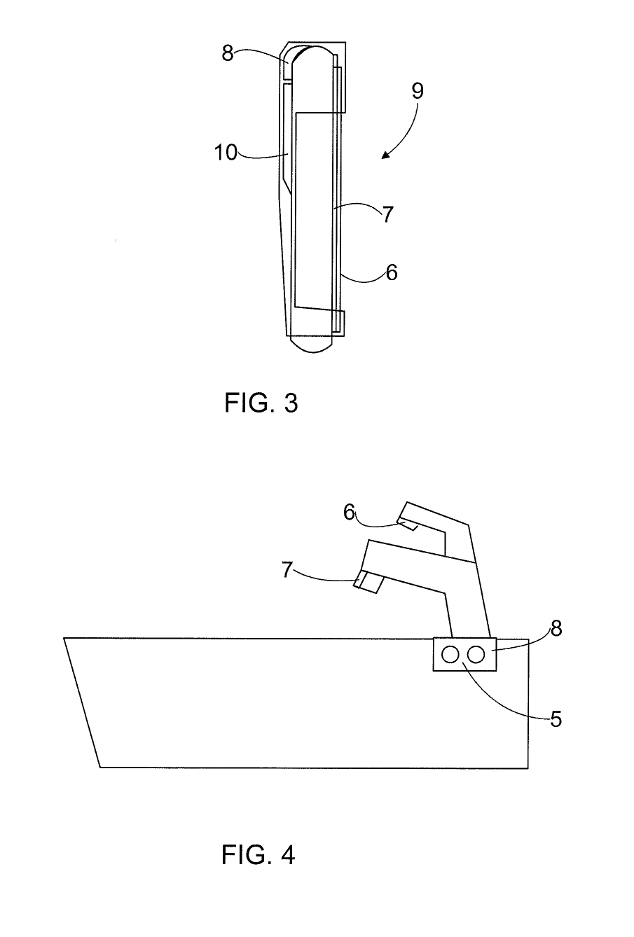

In the embodiment of FIGS. 2 and 3 the object to be examined is a mobile phone 9 and, in particular, the user interface thereof, for example. The user trigger capture module 5 is a two-button diaphragm keyboard attached to the front surface of the mobile phone 9, the buttons being used for indicating a critical event. The input capture module 6, in turn, is a transparent touch screen film. The output capture module 7 is, in turn, is at least partly transparent screen capture film. The screen capture film consists of a matrix of optical sensors laminated into a transparent polymer, for example. The storage module 8 together with a battery 10 is arranged to the back side of the mobile phone 9. The capture modules 5, 6 and 7 are connected to the storage module 8 by a flexible flat cable, for example.

The apparatuses associated with usability testing are arranged to the mobile phone 9 by fastenings 11. Thanks to this the usability testing requires no internal changes to the object to be examined, i.e. all apparatuses associated with the usability testing are physically separate from the object to be examined.

In the solution of FIG. 4, a water tap nozzle is provided with an output capture module 7 containing a water temperature sensor, for example. In addition to the water temperature sensor, the output capture module 7 may contain a battery and a storage module integrated into the same structure.

The water tap handle has an input capture module 6 attached thereto. The input capture module 6 may contain a three-dimensional acceleration sensor, for example, which reads sensor data corresponding to the position of the water tap handle. The input capture module 6 may contain, in addition to the acceleration sensor, a wireless transmitter transmitting measurement data and a battery connected thereto. Hence the input capture module 6 is provided with a power source and a transmitter for wireless transmission of data to the storage module 8.

The storage module 8 and the user trigger capture module 5 may be integrated into one and the same device and may further contain a module for wireless reception of necessary data from the input capture module 6 and an interface for connecting the output capture module 7 for reading captured data and for combining the data with other captured events. The required information is time-stamped to render the captured data into a synchronised data recording.

In other words, in the disclosed solution the storage module 8 preferably comprises a transferrable memory for storing captured events. This makes it easy and simple to analyse data captured of an object to be examined fully separately and, on the other hand, to arrange the storage module 8 in connection with the object to be examined in each particular case.

In the disclosed solutions, usage event data is preferably transferred to a permanent memory only in situations of use in which the user has given feedback with the user trigger capture module 5. In other cases usage event data is stored into a buffer. This is advantageous because this way the memory is not burdened with information of lesser value.

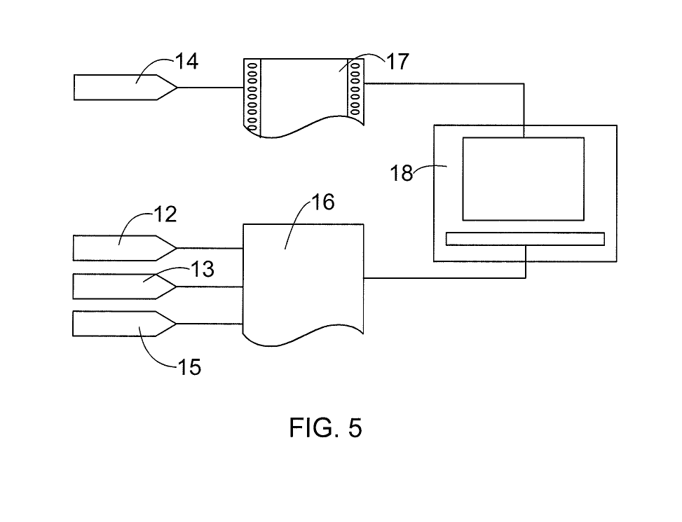

A recording of critical events may be collected into the memory for example in the manner illustrated in FIG. 5. Inputs, such as keyboard press marks 12 and mouse clicks 13, and outputs, such as a display screen capture video 14, are stored into the buffer memory. When a user trigger is received, its time stamp is recorded, i.e. the moment from the beginning of the test, and the trigger type, i.e. whether the user is satisfied or dissatisfied with the object to be tested. From the captured events in the buffer, a sequence of a predetermined length of time, during which the emergence of a critical event has been selected for examination, is transferred into the permanent memory. From the captured events after the critical moment, a sequence of a predetermined length of time, during which the emergence of a critical event has been selected for examination, is transferred into the permanent memory.

Captured keyboard presses 12, mouse clicks 13 and user trigger data 15 arranged into information in a text format in a chronological order is formulated into a subtitling file 16. Each moment of time in the subtitling file 16 is associated with a specific number of identifier data of inputs captured last.

The display screen capture video 14 is formed into a video file 17. The video file 17 and the subtitling file 16 are made into a film recording 18, in which each critical event is a separate sequence. This allows critical events to be examined and browsed with an application or equipment meant for watching films.

The solutions of FIGS. 1, 2, 3 and 4 may be implemented so that the usability test apparatus only contains the means shown in the figures, without any other means. On the other hand, the usability test apparatus may be implemented so that the application to be tested is executed in a virtual machine provided with an operating system required by the application and with a fixed amount of resources allocated for it. The virtual machine and the usability test apparatus are arranged into a physical machine to which the operating system hardware is connected. The apparatus contains the following software modules: an input capture module, an output capture module and a user trigger capture module connected to a storage module implemented by software. The physical machine is provided with a physical memory to which the storage module is connected for storing captured data. In this embodiment also the storage module and the physical memory of the usability test apparatus are connected to the object to be tested independently thereof.

Another way to describe the solution disclosed in this specification is that the storage module 8 is provided with an interface to receive a signal from the output capture module 7, an interface to receive a signal from the input capture module 6, 6a, 6b and an interface to receive a signal from the user trigger capture module 5. Further, the storage module 8 has means for storing signals received over the interfaces. In other words, the storage module 8 may be connected to an object to be tested independently thereof.

Further still, integrated in the same physical device with the storage module 8, there may be an output capture module 7 and an input capture module 6, 6a, 6b. The storage module 8 may contain a memory for storing captured events, but the storage module 8 may also have an interface for connecting a transferrable memory to the storage module, in which case the captured events may be stored into the transferrable memory.

Hence the object to be tested may be a physical product or a user interface thereof, some other computer program or service or a similar solution that the user interacts with.

In some cases, features disclosed in this application may be used as such, irrespective of other features. On the other hand, features disclosed in this application may, if required, be combined to form various combinations.

The drawings and the related description are only intended to illustrate the idea of the invention. Details of the invention may vary within the claims.

1-15. (canceled)

16. An apparatus for usability testing, the apparatus comprising an output capture module for capturing at least one type of output, an input capture module for capturing at least one type of input, a user trigger capture module for capturing at least one type of test user trigger, and at least one storage module for saving at least some of the captured events, wherein the user trigger capture module and the storage module are connected to an object to be tested independently thereof.

17. An apparatus according to claim 16, wherein the user trigger capture module and the storage module are connected between the object to be tested and a user in a physical manner separated of the object to be tested.

18. An apparatus according to claim 16, wherein the object to be tested is a mobile device on top of which the apparatus for usability testing has been attached.

19. An apparatus according to claim 16, wherein the output capture module comprises an at least partly transparent display capture film.

20. An apparatus according to claim 16, the apparatus further comprising at least one transmitter for wireless transmission of data to the storage module.

21. An apparatus according to claim 16, wherein the storage module comprises a transferrable memory for storing captured events.

22. An apparatus according to claim 16, wherein the user trigger is a conscious action of the user.

23. A method for usability testing, the method comprising capturing with an output capture module at least one type of output associated with a tested object, capturing with an input capture module at least one type of input associated with the tested object, capturing with a user trigger capture module at least one type of user trigger of a critical event and storing with the storage module at least part of the outputs and inputs associated with the critical event, whereby the capture and storage of the outputs, inputs and critical events takes place independently of the object to be tested.

24. A method as claimed in claim 23, wherein usage event data is transferred to a permanent memory only of usage situations where the user has provided a user trigger of a critical event.

25. A method according to claim 23, wherein the input and the user trigger of a critical event are formed into a subtitling file, the output is formed into a video file, and the subtitling file and the video file are combined into a film recording, in which each critical event is a separate sequence.

26. A method according to claim 23, wherein captured outputs, inputs and critical events are stored into a transferrable memory.

27. A method according to claim 23, wherein the user trigger is a conscious action of the user.

28. A device for usability testing, the device comprising a storage module with an interface for receiving a signal from an output capture module, an interface for receiving a signal from an input capture module, an interface for receiving a signal from a user trigger capture module and means for storing the signals received through the interfaces, wherein the storage module is connectable to an object to be tested independently thereof.

29. A device according to claim 28, wherein integrated in the same physical device with the storage module, there is an output capture module and an input capture module.

30. A device according to claim 28, wherein the storage module has an interface for connecting a transferrable memory to the storage module for storing signals.
